(19) United States
(12) Patent Application Publication
(10) Pub. No.: US 2018/0112109 A1
(43) Pub. Date: Apr. 26, 2018

(54) PHYSICAL PRETREATMENT FOR FILAMENT FIXATION

(71) Applicant: TESA SE, Norderstedt (DE)

(72) Inventors: Marcel HÄHNEL, Klein Nordende (DE); Jennifer KIPKE, Hamburg (DE); Christoph NAGEL, Hamburg (DE); Jannik SELLIN, Hamburg (DE)

(73) Assignee: TESA SE, Norderstedt (DE)

(21) Appl. No.: 15/783,507

(22) Filed: Oct. 13, 2017

(30) Foreign Application Priority Data
Oct. 21, 2016 (DE) 10 2016 220682.6

(51) Int. Cl. C09J 7/02

(52) U.S. Cl. CPC C09J 7/0285; C09J 2400/14; C09J 2467/006

(57) ABSTRACT

Method for producing an adhesive tape including the steps of providing an adhesive layer to at least one side of a liner or a carrier film and treating at least one filament and/or the adhesive layer with a plasma, and introducing the at least one filament into the adhesive layer.

This application claims priority of German Patent Application No. 10 2016 220 682.6, filed on Oct. 21, 2016, the entire contents of which is incorporated herein by reference.

The invention relates to a method for producing an adhesive tape, the invention further relates to an adhesive tape.

### BACKGROUND OF THE INVENTION

Transport securing tapes are known in the prior art, the production of which requires essentially three carrier film materials: MOPP, (stretched) PET and laminates of thin BOPP/PET carrier films with glass fibres and PET fibres.

While some properties of the transport adhesive tapes are attributable to the adhesive layer or other functional layers of the transport adhesive tape, the stretchability and tensile strength of the transport adhesive tape are based essentially on the physical properties of the carrier film material used in the transport adhesive tape.

As a rule, oriented carrier films are used for transport securing adhesive tapes because of the particular mechanical demands placed on them. The mechanical properties can be influenced precisely by orientation, which is synonymous with stretching the primary film that is formed substantially in the manufacturing process in one or more preferred directions. “Biaxially oriented films” may be stretched sequentially, in which case after the primary film is formed by extrusion through a sheet extrusion die it is first stretched in the direction of the machine by passing it over a series of rollers, wherein the transport speed of the film is greater than the speed at which it leaves the extrusion die. The film is then stretched transversely in a drawing frame. Stretching the film in two directions may also be carried out in a single step (compare for example U.S. Pat. No. 4,675,582 A and U.S. Pat. No. 5,072,493 A).

There are also adhesive tapes on the market in which the BOPP carrier films have been stretched in a blown film process.

In a preferred embodiment carrier films for transport securing adhesive tapes are only stretched in the direction of the machine. With this method, it is possible to obtain polypropylene films with the highest tensile strengths and moduli. Usually, the stretching ratio used, that is to say the ratio between the length of a primary film compartment and the corresponding length of the end product, is between 1:5 and 1:10. Stretching ratios between 1:7 and 1:8.5 are particularly preferred. The very strong resistance to stretching of polypropylene films that have only been oriented monoaxially is one of the most important properties for their use.

The active principle of orienting is in the alignment of the polymer molecule chains and the crystal structures formed therefrom, and in the alignment of the amorphous areas into certain preferred directions and the increase in strength associated therewith. However, according to the same principle the strength in the direction in which the film is not oriented is reduced. Accordingly, in the case of the BOPP and BOPET films, and most especially in the case of the MOPP films, the films possess significantly less strength in the z-direction (the direction in which the film is stretched the least).

One of the disadvantages of conventional MOPP and stretched PET is that they possess high stretchability, greater than 25 to 30%, and are thus very yielding under load. This stretching can cause the transport goods that are secured with an adhesive tape of such kind to become detached, so that they are no longer adequately secured.

MOPP and stretched PET also have the drawback that they both tear very easily if their edges are damaged. Since normal uses also require objects with sharp edges to be secured, the adhesive tape can easily be damaged and tear when used for these tasks.

A further drawback associated with BOPP and MOPP is that they split easily in the direction of the machine if they suffer a transverse impact, in other words they have low tensile impact strength. However, the adhesive tapes are often affixed in the lengthwise direction over a gap (in a refrigerator door, for example). During transport, strong forces may be exerted transversely to the adhesive tape, causing it to tear in the lengthwise direction. Its function of securing during transport is thus no longer guaranteed.

To improve this situation, adhesive tapes made for example from stretched PET or BOPP may be reinforced with filaments of glass fibres in addition to the carrier film. The filaments lend the adhesive tape good tensile strength. Depending on the material used, they have a defined stretchability, glass fibre filaments are preferably used for low stretching.

All monodirectional reinforcing means do not lend the adhesive tape any tensile strength in the transverse direction, which means that the drawback described previously persists for the application of the example over a gap (in a door). Tensile strength and tensile impact strength in the transverse direction are not improved.

A disadvantage of the known adhesive tapes is that due to the surface properties of the filaments, the firmness with which they are embedded in the adhesive is variable.

It is therefore the object of the present invention to provide a method for producing an adhesive tape which has good tensile strength but is simple to manufacture and in which the filaments are fixed securely in the adhesive.

### SUMMARY OF THE INVENTION

In a first aspect, this object is solved with a method having the features of claim 1.

The invention makes use of the idea of providing an adhesive layer preferably over the full expanse on one side of a liner or carrier film, and treating at least one filament and/or the adhesive layer with a plasma.

Preferably, a surface of the at least one filament, preferably the entire surface thereof is treated with plasma and introduced into the adhesive layer; due to the plasma treatment of preferably the entire surface of the filament, the filament is fixed extremely securely in the adhesive of the adhesive layer that surrounds it. The plasma-treated filament is preferably deposited on a surface of a first adhesive layer. The filaments sink into the adhesive. If not before, the filaments are pressed into the adhesive when the adhesive tape is placed over them, so that the adhesive can surround them. Preferably, a second adhesive layer is then applied over the first adhesive layer and the at least one filament.

In another embodiment of the invention, a first adhesive layer is applied to the liner or the carrier film, a surface of the first adhesive layer is treated with plasma and the at least one filament is applied to the plasma-treated surface of the first adhesive layer, and more preferably a second adhesive layer is applied over the at least one filament and the plasma-treated surface of the first adhesive layer.

The first and second adhesive layers may comprise or consist of the same adhesive or different adhesives.

It is also provided, instead of treating either the at least one filament or the first adhesive layer with plasma, to also treat both with plasma.

Initially, the production method according to the invention makes use of a liner or a carrier film, to which the adhesive layer is applied directly or with the additional application of further layers.

### DETAILED DESCRIPTION

Films such as PA, PU, PVC, polyolefins or polyester, more preferably a polyester of PET (polyethylene terephthalate), are particularly suitable for use as the carrier film. In turn, the films themselves may consist of multiple single plies, plies that have been co-extruded to form the film for example.

Polyolefins are used for preference, copolymers of ethylene and polar monomers such as styrene, vinyl acetate, methyl methacrylate, butyl acrylate or acrylic acid are also suitable. It may be a homopolymer such as HDPE, LDPE, MDPE or a copolymer of ethylene with a further olefin such as propene, butene, hexene or octene (for example LLDPE, VLLDE). Polypropylenes (for example polypropylene homopolymers, polypropylene random copolymers or polypropylene block copolymers) are also suitable.

Monoaxially and biaxially stretched films lend themselves extremely well for use as films according to the invention. For example, monoaxially stretched polypropylene is characterized by extremely high tear strength and low lengthwise stretching.

Particularly preferred are films based on polyester, more particularly those consisting of polyethylene terephthalate.

The film preferably has a thickness of 12 μm to 100 μm, more preferably of 28 μm to 50 μm, particularly 36 μm.

The film may be colored and/or transparent.

In order to ensure that in the case of the adhesive tapes without a carrier according to the invention and consisting of only one, two or more adhesive layers the pressure-sensitive adhesives do not come into contact with each other, the adhesive tapes are applied to a liner before they are wound up, which liner is wound up together with the adhesive tape. The person skilled in the art also knows liners of this kind as release liners.

A liner (separating paper, separating film) is not a component of an adhesive tape or label, it is merely an aid for manufacturing and storing them, or for further processing by punching. Furthermore, a liner, by contrast with an adhesive tape carrier, is not firmly bonded to an adhesive layer.

Anti-adhesive coating compounds are used in large quantities in the production of liners to coat particularly two-dimensional materials such as papers or films, in order to reduce the tendency of adhesive products to adhere to these surfaces.

If an adhesive tape with adhesive on both sides and furnished with a liner is unrolled, it is normally adhesively bonded to a base with the side on which the pressure-sensitive adhesive is exposed, that is to say on which there is no liner. At the same time, the other side with pressure-sensitive adhesive sticks to the coated surface of the liner but only enough to make handling the adhesive tape easier.

It should be noted that it must be possible to peel the liner off the adhesive tape. The adhesive strength of the pressure-sensitive adhesive must not be substantially reduced for subsequent use either by the liner itself or by the detachment of the liner.

At the same time, the stability of the anti-adhesive coating (also called the release coating) on the liner, in other words the quality of abhesion over long periods is important in order to guarantee the function of this coating and the properties of the pressure-sensitive adhesive that is covered with the liner.

Separating agents, also called releases, may be created in various ways. Suitable separating agents comprise surfactant release systems based on long-chain alkyl groups such as stearyl sulfosuccinates or stearyl sulfosuccinamates, and also polymers which may be selected from the group consisting of polyvinylstearyl carbamates, polyethylene iminestearyl carbamides, chromium complexes of C₁₄-C₂₈ fatty acids and stearyl copolymers such as are described in DE 28 45 541 A (U.S. Pat. No. 4,331,718) for example. Separating agents based on acrylic polymers with perfluorinated alkyl groups, silicones or fluorosilicone compounds based on poly(dimethyl-)siloxanes for example are also suitable. The release layer particularly preferably comprises a silicone-based polymer. Particularly preferred examples of such active silicone-based releasing polymers include polyurethane-modified and/or polyurea-modified silicones, preferably organopolysiloxane/polyurea/polyurethane block copolymers, particularly preferably such as described in example 19 of EP 1 336 683 B1 (U.S. Pat. No. 6,815,069), most particularly preferably anionically stabilized polyurethane-modified and polyurea-modified silicones with a weight proportion of silicone of 70% and an acid number of 30 mg KOH/g. The use of polyurethane-modified and/or polyurea-modified silicones reliably ensures that the products according to the invention exhibit optimized separating behavior together with optimized resistance to ageing and universal writing properties. In a preferred embodiment of the invention, the release layer comprises 10 to 20 wt %, particularly preferably 13 to 18 wt % of the active separating component.

In this case, at least one filament is understood to refer to either single fibrous, elongated threads, or preferably a filament scrim or filament woven, for example a chain-stitched fabric with weft threads, such as are described in EP 1 818 437 A1, for example.

The use of filament scrims or filament wovens is particularly preferred.

The filament scrim or woven has a tensile strength in the direction of the machine of preferably at least 100 N/cm, more preferably 200 N/cm, particularly preferably 1000 N/cm.

The yarns for creating the scrim or woven preferably have a strength from 80 to 2200 dtex, preferably 280 to 1100 dtex.

For the purposes of this invention, a filament is understood to be a bundle of parallel, straight, single fibres, which is also often referred to in the literature as a multifilament. Optionally, this fibre bundle may be consolidated by twisting it, in which case the filaments are said to be spun or twined. Alternatively, the fibre bundle may be consolidated by agitating with compressed air or a water jet. In the subsequent text, the general designation of filament will be used to refer to all of these embodiments.

The filament may be textured or smooth and may be spot-consolidated or not consolidated at all.

The single filaments are preferably adhesively bonded together to form the at least one filament by means of a binding agent of a so-called sizing agent.

The single filaments preferably consist of the group of PET fibres, carbon fibres, Kevlar fibres or glass fibres, the single filaments may also consist of polyester, polypropylene, polyethylene or polyamide, preferably polyester (diols).

The filaments are preferably each formed from single filaments of the same material, but it is also conceivable to prepare the filaments by bundling single filaments of different materials.

According to a preferred embodiment of the invention, glass fibres are used to form the filaments. In this context, one glass fibre constitutes a single filament as defined previously. The single filaments may also be bundled to form a filament using binding agents, a finishing agent or sizing agent. Then, it is easy to stick the single filaments together. The filament is then preferably made entirely from glass fibre single filaments.

Depending on the sizing agent used, the filament consisting of a bundle of single filaments, preferably single glass fibres has a different surface composition and different surface properties, as a result of which the firmness with which the filaments are fixed in the surrounding adhesive is variable. The wetting and anchoring of the filament with the adhesive are among the factors that are fundamental for fixing the filament in the adhesive.

In order to be able to produce the adhesive tape according to the invention, all known adhesive systems are eligible for use.

Besides natural or synthetic rubber-based adhesives, particularly silicone and polyacrylate adhesives are usable, preferably a low-molecular acrylate hot melt adhesive. The latter substances are described in greater detail in DE 198 07 752 A1 (U.S. Pat. No. 6,432,529) and in DE 100 11 788 A1 (U.S. Pat. No. 6,541,707). Acrylate-based, UV-crosslinking adhesives are also suitable.

The coating weight is preferably in the range between 15 and 200 g/m², more preferably between 30 and 120 g/m², particularly preferably 50 g/m² (roughly corresponding to a thickness of 15 to 200 μm, more preferably 30 to 120 μm, particularly preferably of 50 μm).

The adhesive is preferably a pressure-sensitive adhesive, that is to say a viscoelastic compound which is permanently tacky and remains capable of adhesion at room temperature in the dry state. Adhesion is assured immediately and on almost all substrates with light pressure.

Pressure-sensitive adhesives based on polymer blocks containing block copolymers are used. These are preferably produced from vinyl aromatics (A-blocks) such as styrene and those produced by polymerization of 1,3-dienes (B-blocks) such as butadiene and isoprene or a copolymer of the two. Mixtures of different block copolymers may also be used. Products that are partly or fully hydrogenated are preferred.

The block copolymers may have a linear A-B-A-structure. It is likewise possible to use block copolymers in radial form and star-shaped and linear multiblock copolymers.

Polymer blocks based on other aromatic-containing homo- and copolymers (preferably C₈- to C₁₂-aromatics) with glass transition temperatures of >approx. 75° C., such as aromatic blocks containing α-methylstyrene may also be used instead of the polystyrene blocks. Polymer blocks based on (meth)acrylate homopolymers and (meth)acrylate copolymers with glass transition temperatures of >+75° C. are also usable. In this context, usable block copolymers include either those which use hard blocks based solely on (meth)acrylate polymers or those which use both polyaromatic blocks, polystyrene blocks for example, and poly(meth)acrylate blocks.

Unless stated otherwise in individual cases, the glass transition temperature characteristics for non-inorganic materials and materials that are not predominantly inorganic, particularly organic and polymeric materials, refer to the glass transition temperature value Tg according to DIN 53765:1994-03 (see section 2.2.1).

According to the invention, block copolymers and the hydrogenated products of such block copolymers, that use further polydiene-containing elastomer blocks e.g., copolymers of multiple various 1,3-dienes, may also be used instead of styrene-butadiene block copolymers and styrene-isoprene block copolymers and/or the hydrogenated products thereof, and thus also styrene-ethylene/butylene block copolymers and styrene-ethylene/propylene block copolymers. Functionalized block copolymers such as maleic anhydride-modified or silane-modified styrene block copolymers are also usable according to the invention.

Typical application concentrations for the block copolymer are in a concentration in the range between 30 wt % and 70 wt %, particularly in the range between 35 wt % and 55 wt %.

Other polymers which may also be present and may replace up to half of the vinyl-aromatic-containing block copolymers include polymers based on pure hydrocarbons, for example unsaturated polydienes such as natural or synthetic polyisoprene or polybutadiene, chemically essentially saturated elastomers for example saturated ethylene-propylene copolymers, α-olefin copolymers, polyisobutylene, butyl rubber, ethylene-propylene rubber and chemically functionalized hydrocarbons such as polyolefins that contain halogen, acrylate or vinylether.

Tackifying resins serve as tackifiers.

Suitable tackifying resins include preferably partially or completely hydrogenated resins based on rosin or rosin derivatives among others. At least partially hydrogenated hydrocarbon resins, for example hydrogenated hydrocarbon resins obtained by partial or complete hydrogenation of aromatic-containing hydrocarbon resins (for example Arkon P and Arkon M range manufactured by Arakawa or Regalite range by Eastman), hydrocarbon resins based on hydrogenated dicyclopentadiene polymers (for example Escorez 5300 range by Exxon), hydrocarbon resins based on hydrogenated C5/C9 resins (Escorez 5600 range by Exxon) or hydrocarbon resins based on hydrogenated C5 resins (Eastotac manufactured by Eastman) and/or mixtures thereof may also be used.

Polyterpene-based hydrogenated polyterpene resins are also usable. The aforementioned tackifying resins can be used either alone or in a mixture.

Light stabilizers such as UV absorbers, sterically hindered amines, antiozonants, metal deactivators, processing agents, terminal block reinforcing resins may typically be used as further additives.

Liquid resins, plasticizer oils or low molecular liquid polymers, for example low molecular polyisobutylenes with molecular weights <1500 g/mol (number average) or liquid EPDM types are typically used as plasticizers, for example.

The adhesive may be applied in the lengthwise direction of the adhesive tape in the form of a strip which is less wide than the adhesive tape carrier.

The coated strip may be 10% to 80% as wide as the carrier material. In such a case, the use of strips with a coating that is 20% to 50% as wide as the carrier material is particularly preferred.

Depending on the intended use, the carrier material may be coated with several parallel strips of the adhesive.

The position of the strip on the carrier is freely selectable, although it is preferably arranged directly on one of the edges of the carrier.

The adhesives may be produced and processed from a solution, a dispersion or from a melt. Preferred production and processing methods are conducted from a solution and a melt. The adhesive is produced particularly preferably from a melt, wherein in particular batch methods or continuous methods may be used. Continuous production of the pressure-sensitive adhesives with the aid of an extruder is particularly advantageous.

Processing from a melt may involve application methods via a nozzle or a calender.

Known methods based on a solution include coatings with doctor blades, knives or nozzles to name but a few.

Finally, the adhesive tape with the carrier film may also include a covering material, by which the one adhesive layer is covered until it is ready for use. All of the materials listed above are also suitable for use as covering materials.

However, the use of a lint-free material is preferred, for example a plastic film or a thoroughly sized, long-fibre paper.

Since different manufacturers typically use different sizing agents to create bundles from the single filaments, the surface compositions of the filaments are variable despite the fact that they consist of single filaments of the same material. In particular, the static shear forces with which the filaments are fixed in the adhesive cement layer may differ very widely. Surprisingly, it has now been found that the filament surface is modified by the treatment of the filament surface with plasma in such a manner that regardless of the sizing agent used the static shear forces converge and increase, with the result that glass fibre filaments for example may be selected independent of the manufacturer; the plasma treatment of the filament surfaces largely eliminates the differences in shear forces of the filament fixed in the adhesive cement. Moreover, in the static shear test the shear forces of the plasma-treated filament in the adhesive layer are greater than those of the filament in the adhesive layer which has not been treated with plasma.

The surface of the at least one filament is treated with a plasma.

Plasma is considered to be the fourth physical state of matter. It is a partially or completely ionized gas. The application of energy generates positive and negative ions, electrons and other physical states, radicals, electromagnetic radiation and chemical reaction products. Many of these phenomena are capable of causing a change in the surface to be treated, i.e. in the at least one filament surface to be treated. Overall, this treatment results in activation of the at least one filament surface, specifically increased reactivity.

A corona treatment, which is a type of plasma treatment, is defined as a surface treatment generated by a high AC voltage between two electrodes with filamentary discharges, wherein the discrete discharge channels are incident on the surface to be treated, see also in this regard Wagner et al., Vacuum, 71 (2003), pages 417 to 436. Ambient air, carbon dioxide or nitrogen and other gas mixtures may be used as the process gas without further qualification.

Particularly in the context of industrial applications, the term “corona” is usually understood to mean dielectric barrier discharge (DBD). In this context, at least one of the electrodes consists of a dielectric, that is to say an insulator, or is coated or covered with such a material. The second electrode is furnished with small radii or tips to generate the corona effect, the effect of large gradients in the electrical field. In this case, the substrate may also function as a dielectric.

The intensity of a corona treatment is expressed as the “dose” in [Wmin/m²], where dose D=P/b*v, where P=electrical output [W], b=electrode width [m], and v=web speed [m/min].

The substrate is almost always placed in or passed through the discharge space between one electrode and a counterelectrode, this being defined as “direct” physical treatment. Weblike substrates are in this case typically passed between an electrode and an earthed roller.

A device for surface treatment by means of a corona discharge is known from FR 2 443 753. In that device, both electrodes are arranged on the same side of the surface that is to be treated of the object, and the first electrodes consist of a plurality of points along which a curved arrangement of a second electrode is provided. An AC voltage of several kV with a frequency of 10 kHz is applied between the two electrodes. The corona discharge along the field lines then acts on the surface as it is transported past, polarizing the surface so that the adhesion properties of an adhesive are improved on the surface that is treated with the corona effect.

It is possible to treat materials of different natures, shapes and thicknesses with more even intensity by dispensing with the discharge filaments such as are used in corona discharges and selecting a dual pin electrode as described in EP 0497996 B1, wherein one separate channel is present for each pin electrode for the purpose of applying pressure. A discharge is created between the two electrode tips and ionizes the gas flow flowing through the channels, converting it into a plasma. This plasma then reaches the surface to be treated in the form of remote or afterglow plasma via the gas flow, and there in particular causes a surface oxidation which improves the wettability of the surface. The nature of the physical treatment is defined (here) as indirect because the treatment is not carried out at the location where the electrical discharge takes place. The treatment of the surface takes place under atmospheric pressure, or approximately thereto, although the pressure in the electrical discharge space or gas channel can be increased. In this context, the plasma is understood to be an atmospheric pressure plasma which is an electrically activated homogeneous reactive gas which is not in thermal equilibrium at a pressure close to atmospheric pressure in the area of action. The gas is activated by the electrical discharges and the ionization processes in the electric field, and highly excited states are generated in the gas components. The gas or gas mixture used are referred to as the process gas. Air, carbon dioxide, inert gases or nitrogen or mixtures thereof may be used as the process gas. In general, other gas-phase substances such as siloxane, acrylic acids or solvents, or hydrogen, alkanes, alkenes, alkynes, silanes, silicon-organic monomers, acrylate monomers, water, alcohols, peroxides and organic acids or other components may also be added to the process gas. Components of the atmospheric pressure plasma may be highly excited atomic states, highly excited molecular states, ions, electrons, unchanged components of the process gas. The atmospheric pressure plasma is not produced in a vacuum, but typically in an air environment. This means that even if the process gas itself is not air, the radiating plasma at least contains components of the ambient air.

In a corona discharge according to the preceding definition, the high voltage applied serves to form filamentary discharge channels with accelerated electrons and ions. The light electrons in particular strike the surface at high speed, with energies that are sufficient to break most molecular bonds. The reactivity of the reactive gas components which are also generated is largely a less important effect. The broken bond sites then continue to react with components in the air or in the process gas. A decisive effect is the formation of short-chain products of decomposition by electron bombardment. In treatments of greater intensity, significant material erosion also takes place.

The reaction between a plasma and the substrate surface enhances the effect of direct “incorporation” of the plasma components. Alternatively, an excited state or an open bond site and radicals may be created on the surface, which then continue with a secondary reaction, with the atmospheric oxygen in the ambient air, for example. With some gases, such as inert gases, a chemical bond between the atoms or molecules of the process gas and the substrate may be discounted. In this case, the activation of the substrate takes place exclusively via secondary reactions.

Accordingly, the essential difference is that with the plasma treatment there is no direct effect on the surface from discrete discharge channels. Thus, the effect takes place homogeneously and gently, and predominantly via reactive gas components. In an indirect plasma treatment, free electrons may be present but not accelerated, since the treatment is carried out outside the generating electrical field.

As a result of the combination of species, the plasma treatment is more uniform and less harsh than a corona treatment, because no discrete discharge channels are incident on the surface. Fewer short-chain products of decomposition of the treated material which might form a layer impairing the surface are created. This is why better wettability characteristics can often be obtained after plasma treatment than after corona treatment, and the effect is retained for longer.

A first adhesive layer is preferably applied to the carrier film, and the at least one plasma-treated filament is applied to the first adhesive layer, and more preferably a second adhesive layer is applied over the at least one plasma-treated filament and the first adhesive layer.

In this embodiment of the invention, in this way the at least one filament is introduced into the adhesive layer so that it is arranged between two adhesive layers, as it were. The two adhesive layers may consist of the same adhesive. However, they may also consist of different adhesives.

To begin, preferably the whole area of the carrier film is wetted with an adhesive layer and then the filament preferably in the form of a rolled product is unrolled, and then undergoes plasma or corona treatment immediately before it is placed on the adhesive layer. Alternatively, it is also possible to treat the filament with plasma, then roll it up again, and unroll it a short time later and then immediately place it on the adhesive layer. Finally, in both cases a further adhesive layer is applied on top. If the adhesive layer and the further adhesive layer consist of the same adhesive, the filament is embedded in the adhesive layer.

It is also possible to pretreat the first adhesive layer in which the at least one filament is to be introduced. The physical pretreatment of this first adhesive layer may be carried out in the same way or differently to the treatment of the at least one filament. The first adhesive layer undergoes pretreatment immediately before the introduction of the filaments.

The object is solved in a second aspect thereof with an adhesive tape having the features of Claim 10. The adhesive tape is preferably produced by one of the methods described in the preceding text.

The adhesive tape according to the invention comprises an adhesive layer and at least one filament introduced into the adhesive layer, wherein the adhesive layer and/or one surface of the at least one filament has been treated with a plasma. Either the at least one filament or the adhesive layer or both may be treated with plasma.

Preferably, a first adhesive layer is treated with plasma and the at least one filament is arranged on the first plasma-treated surface of the first adhesive layer, and a second adhesive layer is applied over the first plasma-treated surface of the first adhesive layer and over the at least one filament.

The invention will be described with reference to an exemplary embodiment in a figure.

### BRIEF DESCRIPTION OF THE DRAWINGS

In the figures

FIG. 1 is a schematic representation of a static shear test,

FIG. 2 shows an exemplary structure of an adhesive tape according to the invention,

FIG. 3 is a graphical representation of the time to detachment of adhesive tape strips from films.

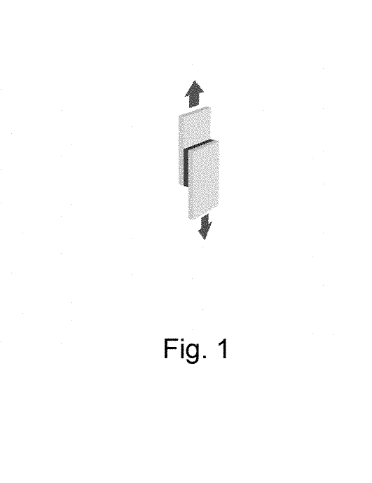

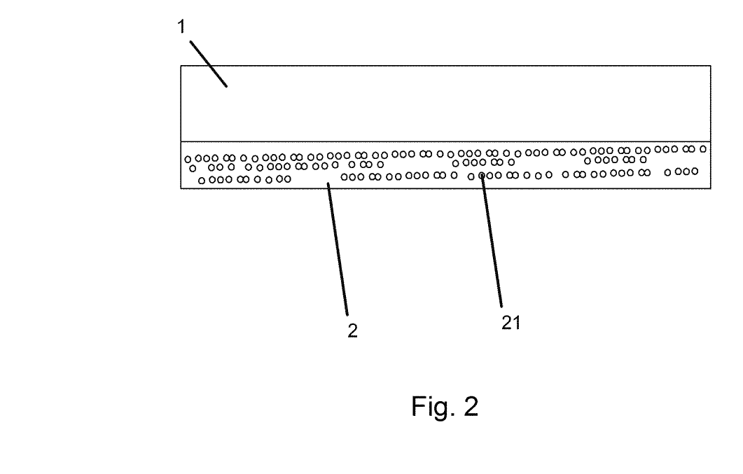

One possible way to test the fixation of a filament in an adhesive layer is to determine the shear resistance of the adhesive bond on a readily bondable base. In this case, an etched PET film was used as the base. A conventional static shear test, the setup for which is represented diagrammatically in FIG. 1 is used as the measuring method to determine the shear resistance. The test is carried out as follows. The etched PET film is affixed to the entire surface of a 2×25×50 mm test plate of non-ground steel. An adhesive tape strip with dimensions 40×13 mm is adhesively bonded to the etched PET film over an area of 20×13 mm; the adhesive tape strip is a film carrier 1 on which a filament layer consisting of glass fibre filaments 21 and coated with a pressure-sensitive adhesive 2 has been positioned; in this case, acrylate adhesive was used as the pressure-sensitive adhesive. FIG. 2 shows the adhesive tape. A weight is fastened to the protruding end of the adhesive tape strip. Pressure of 10 Newton per cm² is applied to an adhesion area for one minute. The sample together with the steel plate is fastened to a sample holder and the weight is attached to the protruding end of the adhesive tape strip. The time until the adhesive tape strip shears off was measured; in this case, the failure profile indicates the failure of the pressure-sensitive adhesive on the filament layer, the pressure-sensitive adhesive is thus left on the etched PET film.

For the sake of simplicity, the adhesive on the strip is only shown in the adhesion area.

Experiments were conducted with two different glass fibre filaments from different manufacturers. The two glass fibre filaments differed from one another only in the sizing agent that was used. The results are represented in the form of a graph:

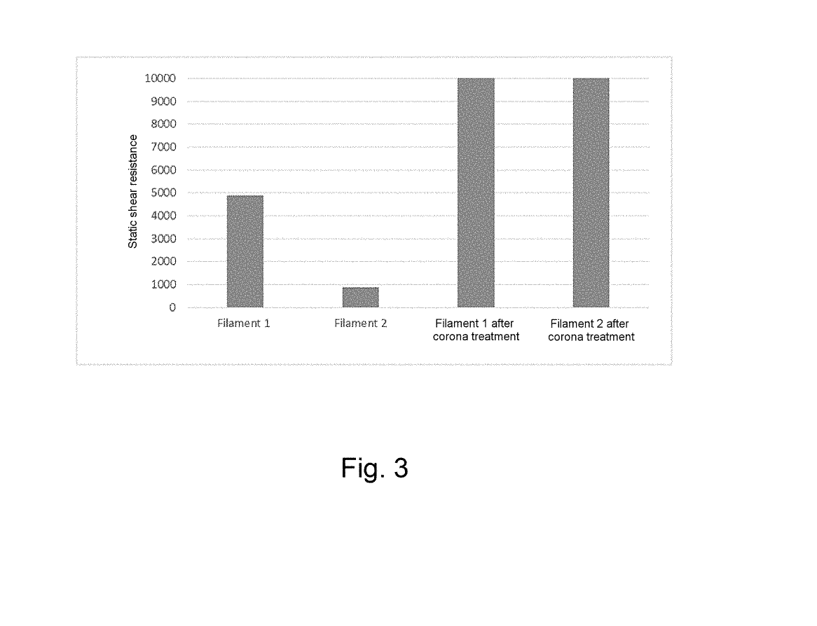

The time to detachment is shown in FIG. 3; in the case of the first filament, the time until the adhesive tape strip sheared off from the PET film was about 4,500 minutes, in the second experiment, this time was only about 1,000 minutes.

In addition, the shear resistances of the same filaments after a corona treatment before the filaments were coated with adhesive were measured.

It should first be noted that the filaments in the untreated state had different shear resistances. Thus it may be assumed that the filaments also have different wettability properties. With the corona treatment as a particular form of plasma treatment, the shear resistance of both filaments is significantly increased and rendered more uniform; it is evident that the plasma treatment results in comparable wettability properties after the plasma treatment, even though the wettability properties of the untreated filaments were different. The physical surface treatment of the filaments with plasma enables filaments that have undergone different pretreatments to be incorporated in the adhesive assembly with the same effect.

### LIST OF REFERENCE SIGNS

1 Carrier film
2 Adhesive layer
21 Filaments

1. Method for producing an adhesive tape, comprising the steps of
providing an adhesive layer on at least one side of a liner or a carrier film, and
treating at least one filament and/or the adhesive layer with a plasma, and
introducing the at least one filament into the adhesive layer.

2. Method according to claim 1,
wherein a first adhesive layer is applied to the liner or the carrier film, and a surface of the at least one filament is treated with plasma and applied to the first adhesive layer, and optionally a second adhesive layer is applied over the at least one plasma-treated filament and the first adhesive layer.

3. Method according to claim 1,
wherein a first adhesive layer is applied to the liner or the carrier film, a surface of the first adhesive layer is treated with plasma and the at least one filament is applied to the first plasma-treated surface of the first adhesive layer, and a second adhesive layer is applied over the at least one filament and the plasma-treated surface of the first adhesive layer.

4. Method according to claim 1,
wherein air, carbon dioxide, inert gases, or nitrogen or mixtures thereof is/are used as the process gas for the plasma treatment.

5. Method according to claim 4,
wherein hydrogen, alkanes, alkenes, alkynes, silanes, silicon-organic monomers, acrylate monomers, water, alcohols, peroxides or organic acids are added to the process gas in the form of vapor or aerosols.

6. Method according to claim 1,
wherein the at least one filament is selected from the group consisting of PET fibers, carbon fibers, Kevlar fibers or glass fibers.

7. Method according to claim 1,
wherein the at least one filament is created from a bundle of single filaments which are bonded with a sizing agent.

8. Method according to claim 7,
wherein glass fibers are bundled together with a sizing agent to form a filament, and filaments with different sizing agents are used to produce the adhesive tape, and all filaments with different sizing agents are treated with plasma.

9. Method according to claim 1,
wherein the entire extent of the at least one filament is treated with plasma.

10. Adhesive tape having an adhesive layer and at least one filament introduced in the adhesive layer,
wherein the adhesive layer and/or one surface of the at least one filament has been treated with a plasma.

11. Adhesive tape according to claim 10,
wherein the at least one filament originates from the group consisting of PET fibers, carbon fibers, Kevlar fibers or glass fibers.

12. Adhesive tape according to claim 10,
wherein the at least one filament consists of glass fiber single filaments bundled together by a sizing agent.

13. Adhesive tape according to claim 10,
wherein the at least one filament has been treated with plasma.

14. Adhesive tape according to claim 10,
wherein the adhesive layer has been applied to a liner or a carrier film.
